(19) United States
(12) Patent Application Publication
(10) Pub. No.: US 2008/0314273 A1
(43) Pub. Date: Dec. 25, 2008

(54) Bank formed substrate and color pattern formed substrate

(75) Inventors: Yukako Tamanuki, Tokyo (JP); Kai Teruhiko, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd, Tokyo (JP)

(21) Appl. No.: 11/820,879

(22) Filed: Jun. 20, 2007

(51) Int. Cl. B41N 3/03

(52) U.S. Cl. 101/465

(57) ABSTRACT

A color pattern formed substrate comprising a transparent substrate; a bank having an ink-repellent property on the transparent substrate; and colored layers resulted from color inks that are formed in the openings of the bank is disclosed. A surface layer portion of the bank has a better ink-repellent property than a lower layer portion thereof. The contact angle between the surface layer portion and a color ink is 30 degrees or greater.

### BACKGROUND OF THE INVENTION

1. Field of the Invention

The present invention relates to a bank formed substrate and color pattern formed substrate for use in color display devices and the like.

2. Description of the Related Art

In recent years, along with the spread of color liquid crystal displays, a demand for reducing the cost of a color filter has increased. In the photo lithography system that is the main stream of producing a color filter in the existing circumstances, not only in the forming process of the black matrix, but also in the forming process of colored layers, a large amount of such raw material as pigment is thrown out at the development. In addition, since a large number of processes are required for the production, there is a limitation on the cost reduction. On the other hand, in an ink-jet system, the formation of respective R, G and B colored layers can be performed at one time, and almost no waste of such raw material as pigment occurs, therefore, a significant cost reduction can be expected.

For a production method of a color filter by using an ink-jet system, for example, there are proposed such methods as described in JP-A-6-347637, JP-A-7-35915, or JP-A-7-35917.

JP-A-6-347637 describes that, in order to prevent the spread of an ink outside a desired colored layer area on a glass substrate, the ink is firmly fixed within the colored layer area by forming patterns while using a black matrix having been previously incorporated with a fluorine-containing water/oil repellant.

In JP-A-7-35915 and JP-A-7-35917, there is such description as the use of a black resin layer containing a fluorine-containing compound and/or a silicon-containing compound for partition walls for preventing ink bleed and color mixing in forming colored layers.

However, in these methods, a small addition amount of a water/oil repellant occasionally generated ink overflow to result in color mixing. In contrast, a large addition amount thereof occasionally resulted in the occurrence of color omission (color void) and color unevenness near the black matrix. Accordingly, the methods had such drawback as extreme difficulty in controlling the optimal addition amount. Further, in order to prevent the ink overflow, the black matrix must be so formed as having a considerable thickness, and thus there was also difficulty in cost.

As described above, conventional techniques had drawbacks in production and cost. The present invention was achieved in order to solve these problems, and aims to provide, in a color pattern formed substrate on which a black matrix having an ink-repellent property is formed and colored layers are formed by charging the bank openings with respective color inks, a color pattern formed substrate excellent especially in color properties without color mixing. Further, the invention aims to provide a method for producing the above-described color filter.

### SUMMARY OF THE INVENTION

In accordance with one embodiment of the invention, a color pattern formed substrate is disclosed comprising a transparent substrate; a bank having an ink-repellent property on the transparent substrate; and colored layers resulted from color inks that are formed in the openings of the bank. The color inks can be formed sequentially. A surface layer portion of the bank can have a greater ink-repellent property than a lower layer portion thereof. The contact angle between the surface layer portion and the color ink can be 30 degrees or greater.

### BRIEF DESCRIPTION OF THE DRAWINGS

FIG. 1 is a cross-sectional view of one example of the color pattern formed substrate of the present invention.

FIG. 2 is an illustrative drawing of the contact angle for a color ink.

### EXPLANATION OF NUMERALS

1 Transparent substrate
2 bank
3 Colored layer
4 Protective layer

### DESCRIPTION OF THE PREFERRED EMBODIMENTS

Hereinafter, the present invention is described on the basis of embodiments.

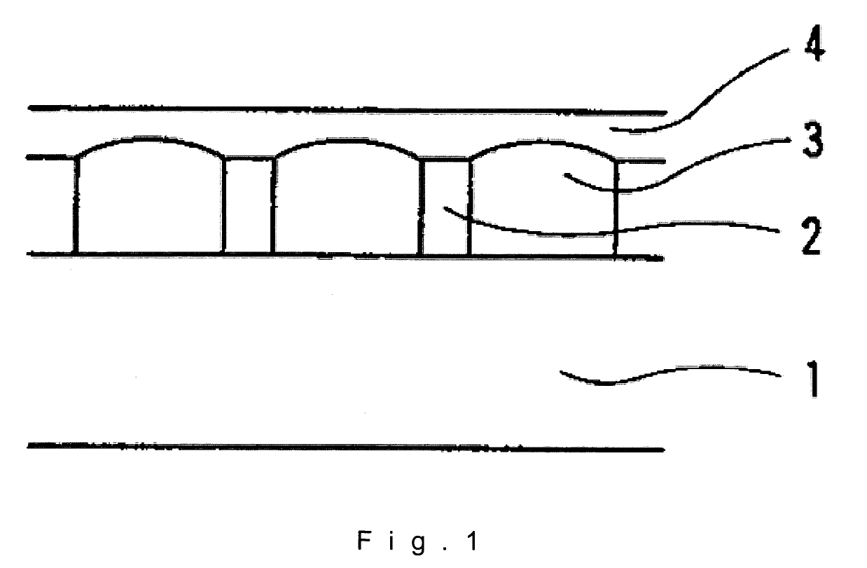

FIG. 1 is a cross-sectional view of one example of a color pattern formed substrate according to the invention. The color pattern formed substrate as shown in FIG. 1 is produced by forming a bank 2 on a transparent substrate 1, then forming colored layers with color inks of red (R), green (G) and blue (B) in openings of the bank 2, and further providing a protective layer 4. By forming R, G, B with an ink-jet system, it is possible to economically and simply produce the colored layers. In addition, as a result of providing the protective layer 4, it is possible to obtain a color pattern formed substrate that is excellent in flatness and various resistance properties.

For the transparent substrate 1 in the invention, a glass substrate, a silica substrate, a plastic substrate etc. can be employed. Among these, the use of a glass substrate can give a color pattern formed substrate excellent in not only transparency, but also strength, heat resistance and weather resistance.

The bank 2 in the invention is desirably formed by coating a bank formation ink composed of a black pigment, a photo-curable resin, a photo initiator, an ink repellent, fine particles, a solvent etc. on a transparent substrate and using a photolithographic method. The usage of a black ink can give a color pattern formed substrate excellent in light shielding properties. Further, the addition of the ink repellent can prevent the outflow of an ink to an adjacent pixel of different color, to prevent color mixing. Furthermore, the addition of fine particles can form fine pores in the bank, to make the absorption of the solvent possible. As a result, color mixing can be prevented even when a large amount of color ink is charged.

The photo-curable resin in the invention is not particularly limited, but a resin, which is cured readily in the photolithographic method in combination with a photo initiator, is selected. For example, such resin monomer or oligomer as aliphatic acrylate, alicyclic acrylate, aromatic acrylate, functional group-containing acrylate containing a OH group or an allyl group or a glycidyl group or a carboxyl group or a chloro group or a bromo group or the like, phosphoric acrylate and metallic acrylate can be used. Or, methacrylates having the same skeleton as the above-described acrylates can be also used. In addition, monomer or oligomer of pyrrolidone and vinyl acetate can be used.

The photo initiator is not particularly limited, but such a general photo initiator as azoisobutyronitrile can be used.

For the black pigment, general pigment among organic black pigment and inorganic black pigment can be used.

The ink repellent in the invention is added for preventing the intrusion of a color ink to adjacent pixels bounded by the bank when charging the color ink. For the ink repellent, silicone-based and fluorine-containing ones are typically used. Specific examples of the ink repellent include, but are not limited to, silicone resin and silicone rubber containing siloxane ingredient, and, in addition, such fluorine-containing resins as vinylidene fluoride, vinyl fluoride, ethylene trifluoride and copolymers thereof.

The use of the ink repellent may occasionally result in bleed out at heating in the production process. The bleed out of the ink repellent leads to the adhesion of the ink repellent on the transparent substrate at openings, to generate color omission etc. at charging an color ink. In order to prevent the bleed out, the use of a fluorine-containing compound as the ink repellent is especially preferred. For example, a fluorine-containing resin having a fluoroalkyl group in a main chain or a side branch, etc. can be mentioned. Compared with a low molecular weight compound, the use of an oligomer type one can more effectively prevent the bleed out.

For fine particles in the invention, any of inorganic fine particles, organic fine particles, and organic-inorganic complex fine particles can be employed. Particles having a particle diameter of 500 nm or smaller are used. The particle diameter here means a primary or a secondary particle diameter. A particle diameter greater than 500 nm results in a large size of fine pores among the fine particles. Therefore, when pigment is used as the colorant of a color ink, the pigment of the color ink penetrates into the bank and the color ink must be charged in larger quantity.

The lower limit of the particle diameter is 5 nm or greater, more preferably 10 nm or greater. The particle diameter smaller than the lower limit makes fine pores among the fine particles small not to allow the solvent of a color ink to be absorbed easily, which is not preferred.

When the content of the fine particles is less than 10 weight % relative to the total solids of the bank formation ink being 100 weight %, then no fine pore is formed in the bank, and, therefore, the solvent of the color ink is absorbed insufficiently. On the other hand, when it is more than 60 weight %, then the film becomes brittle, which is not preferred. Preferably it is within a range from 10 weight % to 60 weight % relative to the total solids. The optimal content varies depending on the type and particle diameter of fine particles, but, more preferably it is within a range from 40 weight % to 50 weight %.

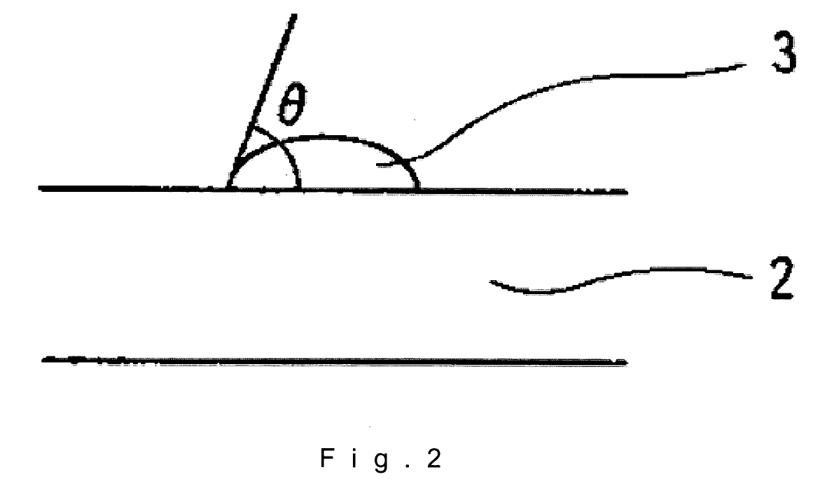

In order to reduce color mixing with adjacent color patterns when the color ink is poured into the opening of the bank, preferably the contact angle between the surface portion of the bank and the color ink is 30 degrees or greater. A contact angle of 35 degrees or greater is preferred because the flatness of the colored layer is improved. More preferred is 40 degrees or greater. In case where it is 40 degrees or greater, the color mixing to adjacent pixels rarely occurs even when the color ink is charged quickly at once. In case where the contact angle is smaller than 30 degrees, the color mixing with adjacent color patterns occurs easily, which causes the decrease in the yield (see FIG. 2).

A method for making the ink repelling property of the surface portion of the bank greater than that of the lower portion is not particularly limited. For example, a good solvent and a poor solvent having different solubility for the ink repellent with each other are prepared, and, on this occasion, the poor solvent is so selected that it has a higher boiling point than the good solvent. These two types of solvents are mixed for use as a solvent for the bank composition. When forming the bank by using the bank composition, drying the coated film under a constant condition allows the good solvent having a lower boiling point to evaporate earlier. Consequently, the ink repellent is unevenly distributed to the surface or upper surface along with the evaporation. In addition, the ink repellent may be moved toward a surface of the bank by prebaking treatment. The ink repellent is unevenly distributed to the surface or upper surface

As described above, it is possible to make the ink-repellent property of the surface portion of the bank greater than that of the lower portion thereof. It is possible to achieve such condition that an contact angle between the surface portion of the bank and the color ink is 30 degrees or greater by mixing a good solvent and a poor solvent.

The measurement of the ink-repellent property at the surface layer portion of the bank and the ink-repellent property at the lower portion may be carried out by polishing the bank and measuring the contact angle between the polished surface and the color ink. The polishing is carried out, for example, till the thickness becomes ⅓ of the initial value.

The material of color inks used for colored layers 3 is composed of a colorant, resin, a dispersing agent, a solvent and the like. For the colorant, both pigment and dye can be employed, but, from the viewpoint of excellent weather resistance, the use of pigment is preferred. Specific examples of the pigment used as the colorant include, but are not limited to, Pigment Red 9, 19, 38, 43, 97, 122, 123, 144, 149, 166, 168, 177, 179, 180, 192, 215, 216, 208, 217, 220, 223, 224, 226, 227, 228, 240, Pigment Blue 15, 15:6, 16, 22, 29, 60, 64, Pigment Green 7, 36, Pigment Red 20, 24, 86, 81, 83, 93, 108, 109, 110, 117, 125, 137, 138, 139, 147, 148, 153, 154, 166, 168, 185, Pigment Orange 36, and Pigment Violet 23.

Further, in order to obtain a requested hue, these may be used in a mixture of two or more types thereof. Examples of the usable resin include casein, gelatin, polyvinyl alcohol, carboxymethyl acetal, polyimide resin, acrylic resin, epoxy resin, and melamine resin, which are arbitrarily selected while taking the relation with the colorant into consideration. When heat resistance or light resistance is required, acrylic resin is preferred.

In order to improve the dispersion of the colorant in the resin, a dispersing agent may be used. For the dispersing agent, such nonionic surfactant as polyoxyethylene alkylether, such ionic surfactant as sodium alkylbenzene sulfonate, poly fatty acid salt, fatty acid salt alkyl phosphate, and tetraalkylammonium salt, and, in addition, organic pigment derivatives and polyester can be mentioned. One type of dispersing agent may be used separately, or two or more types may be used in a mixture.

For forming the colored layer 3 in the invention, the use of an ink-jet system is best. An ink-jet apparatus to be used is classified into a piezo conversion system and a heat conversion system, based on difference in an ink discharge system. In particular, a piezo conversion system is suitable. Preferred is an apparatus with an ink atomizing frequency of around 5 to 100 kHz and a nozzle diameter of around 5 to 80 μm, having three heads, each of which has 60 to 500 nozzles. Drying or UV-curing may be carried out according to need.

The color ink for forming the colored layer 3 with an ink-jet system is preferably adjusted to have a surface tension of 35 mN/m or smaller, which is a suitable range for the ink-jet system, and a boiling point of 130° C. or higher. A surface tension greater than 35 mN/m has a significantly harmful effect on the stability of the dot shape at the discharge of ink-jet, and a boiling point of lower than 130° C. leads to a significantly high drying property near the nozzle, to result in the occurrence of such trouble as nozzle clogging, which are not preferred.

The surface tension and boiling point are adjustable with a solvent to be used. Specific examples of usable solvents include, but are not limited to, 2-methoxyethanol, 2-ethoxyethanol, 2-buthoxyethanol, 2-ethoxyethylacetate, 2-buthoxyethylacetate, 2-methoxyethyl acetate, 2-ethoxyethyl ether, 2-(2-ethoxyethoxy)ethanol, 2-(2-buthoxyethoxy)ethanol, 2-(2-ethoxyethoxy)ethyl acetate, 2-(2-buthoxyethoxy)ethyl acetate, 2-phenoxyethanol, and diethylene glycol dimethyl ether. Two or more types of the solvents may be used in a mixture according to need, and are arbitrarily selected while also taking the solubility into consideration.

The color pattern formed substrate of the invention can be provided with a protective layer 4 as the upper layer according to need. The protective layer is desirably formed of a transparent resin film. This improves the flatness of the surface and weather resistance.

The invention is a color pattern formed substrate comprising a bank having an ink-repellent property, and colored layers formed by charging the openings of the bank with respective color inks on a transparent substrate, wherein the bank is a bank formed by using a photo-curable resin, a photo initiator, an ink repellent. In addition, the adding of a black pigment to the bank allows the bank to be a black matrix. Further, fine particles having a particle diameter of 500 nm or smaller can be included in the bank, therefore minute fine pores are formed in the bank to make it possible to absorb a part of the solvent of the color ink at charging the color ink. Accordingly, the bank has the absorption effect of the color ink solvent, as well as the ink-repellent effect, to make it possible to give a color pattern formed substrate with a little color mixing and a high pattering accuracy.

In the invention, since the fine particle content is from 10 weight % to 60 weight % relative to the total solids of the bank formation ink being 100 weight %, the solvent of the color ink can be sufficiently absorbed not to make the film brittle.

Further, since the ink repellent is constituted of a fluorine-containing compound, no color void caused by the outflow of the ink repellent into the openings due to bleed out is generated.

Furthermore, the surface layer portion of the bank has a greater ink-repellent property than the lower layer portion, and the contact angle between the surface layer portion and the color ink is 30 degrees or greater, therefore the pixel flatness of the colored layers is improved.

In addition, in the invention, charging the color inks can be carried out with an ink-jet system, therefore it is possible to provide economically a color pattern formed substrate having a high patterning accuracy and excellent color properties.

This application is incorporated by reference which is Japanese application number 2004-357896, which is filed on Dec. 12, 2004.

### EXAMPLE 1

Hereinafter, Examples of the present invention are described concretely as an example of the color filter.

### (Formation of Black Matrix)

10 weight parts of a polyimide precursor (Toray: Semicofine SP-510), 7.5 weight parts of carbon black, 130 weight parts of NMP, 5 weight parts of a dispersing agent (copper phthalocyanine derivative), 5 weight parts of triazine (initiator), and 0.1 weight part of perfluoroalkyl oligomer were dispersed with a bead mill dispersing machine for three hours with cooling.

Separately in addition, for fine particles, dry silica (Japan Aerosil: secondary particle diameter of 300 nm) was dispersed in a solvent, which was added to the above-described dispersion so as to give 20 weight % of a silica solid relative to the solid content of the dispersion being 100 weight %, and then dispersed with a bead mill dispersing machine for two hours, to prepare a black matrix composition. The black matrix composition was coated on an alkali-free glass substrate (Corning, Product No. 1713) with a spin coater to form a coated film having a thickness of 1.5 μm, which was then heat-cured at 100° C. for 20 minutes to form a black matrix.

### (Preparation of Color Inks)

20 parts of methacrylic acid, 10 parts of methyl methacrylate, 55 parts of butyl methacrylate and 15 parts of hydroxyethyl methacrylate were dissolved in 300 grams of butyl lactate, to which 0.75 part of azobisisobutyronitrile was added under nitrogen atmosphere, and, through the reaction at 70° C. for 5 hours, acrylic copolymerization resin was obtained. The obtained acrylic copolymerization resin was diluted with propylene glycol monomethyl ether acetate to give the acrylic copolymerization resin concentration of 10%, thereby preparing the diluted solution of the acrylic copolymerization resin. To respective 80.1 grams of the diluted solution, respective 19.0 grams of pigments and 0.9 gram of a dispersing agent were added, which were then kneaded with a three-roll system to give respective colored varnishes of red, green and blue. Each of the colored varnishes was adjusted with propylene glycol monomethyl ether acetate to give the pigment concentration of 12-15% and the viscosity of 15 cps, to give the color inks of R, G and B.

### (Formation of a Color Filter)

In the openings of the black matrix on the glass substrate, the respective patterned colored layers 3 of red (R), green (G) and blue (B) were formed by using the above-described R, G and B color inks with an ink-jet printing apparatus mounted with a 12 pl, 180 dpi head (Seiko Instruments).

The thus obtained color filter substrate gave a color filter having no color mixing, an excellent density balance, a distinct pixel shape and sharp pixel edge.

### EXAMPLE 2

### Formation of Black Matrix

A black matrix was formed in the same way as in Example 1 except that colloidal silica (Nissan Chemical Industries: particle diameter of 40 nm) was used as fine particles.

### (Preparation of Color Inks)

The color inks were prepared in the same way as in Example 1.

### (Formation of a Color Filter)

In the openings of the black matrix on the glass substrate, the respective patterned colored layers 3 of red (R), green (G) and blue (B) were formed by using the above-described R, G and B color inks with an ink-jet printing apparatus mounted with a 12 pl, 180 dpi head (Seiko Instruments). The thus obtained color filter substrate gave a color filter having no color mixing, an excellent density balance, a distinct pixel shape and sharp pixel edge.

### EXAMPLE 3

### Comparative Example 1

### Formation of Black Matrix

10 weight parts of a polyimide precursor (Toray: Semicofine SP-510), 7.5 weight parts of carbon black, 130 weight parts of NMP, 5 weight parts of a dispersing agent (copper phthalocyanine derivative), and 5 weight parts of an initiator (triazine) were dispersed with a bead mill dispersing machine for three hours with cooling to prepare a black matrix composition. The black matrix composition was coated on an alkali-free glass substrate (Corning, Product No. 1737) with a spin coater to form a coated film having a thickness of about 1.5 μm. Through the heat curing at 100° C. for 20 minutes, a black matrix was formed.

### (Preparation of Color Inks)

The color inks were prepare in the same way as in Example 1.

### (Formation of a Color Filter)

In the openings of the black matrix on the glass substrate, the respective patterned colored layers 3 of red (R), green (G) and blue (B) were formed by using the above-described R, G and B color inks with an ink-jet printing apparatus mounted with a 12 pl, 180 dpi head (Seiko Instruments). The thus obtained color filter substrate showed partial color mixing.

### INDUSTRIAL APPLICABILITY

The color pattern formed substrate and bank formed substrate obtained in the present invention can be utilized as a color filter substrate for liquid crystal displays, electric paper, and white EL displays. Moreover, it is possible to use it for the electronic luminescence device. The production of the color pattern formed substrate according to the invention can be carried out economically and simply, to give color pattern formed substrate capable of answering to small lot production.

What is claimed is:

1. A bank formed substrate comprising:
a transparent substrate; and
a bank having an ink-repellent property on the transparent substrate,
wherein a surface layer portion of the bank has a greater ink-repellent property than a lower layer portion thereof, and a contact angle between the surface layer portion and an ink is 30 degrees or greater.

2. The bank formed substrate according to claim 1, wherein:
the ink-repellent property of the surface layer portion of the bank is better than that of the lower layer portion thereof and the contact angle between the surface layer portion and the ink is 35 degrees or greater.

3. The bank formed substrate according to claim 1, wherein:
the ink-repellent property of the surface layer portion of the bank is better than that of the lower layer portion thereof and the contact angle between the surface layer portion and the ink is 40 degrees or greater.

4. The bank formed substrate according to claim 1, wherein:
the bank comprises an ink repellent including a fluorine-containing compound.

5. The bank formed substrate according to claim 1, wherein:
the bank comprises an ink repellent including of a fluorine-containing compound and the fluorine-containing compound is an oligomer type one.

6. The bank formed substrate according to claim 1, wherein:
the surface tension of the ink is 35 mN/m or smaller.

7. The bank formed substrate according to claim 1, wherein:
the bank is composed of a single layer.

8. The bank formed substrate according to claim 1, wherein:
the bank is formed by using a bank formation ink comprising a black pigment, a photo-curable resin, a photo initiator, an ink repellent and fine particles, and the fine particles have a particle diameter of 500 nm or smaller.

9. The bank formed substrate according to claim 1, wherein:
the bank is formed by using a bank formation ink comprising a black pigment, a photo-curable resin, a photo initiator, an ink repellent and fine particles, and the content of the fine particles is from 10 weight % to 60 weight % relative to the total solids of the bank formation ink being 100 weight %.

10. A color pattern formed substrate comprising:
a transparent substrate;
a bank having an ink-repellent property on the transparent substrate; and
colored layers resulted from color inks in openings of the bank,
wherein a surface layer portion of the bank has a greater ink-repellent property than a lower layer portion thereof, and a contact angle between the surface layer portion and an color ink is 30 degrees or greater.

11. The color pattern formed substrate according to claim 10, wherein:
the ink-repellent property of the surface layer portion of the bank is better than that of the lower layer portion thereof and the contact angle between the surface layer portion and the color ink is 35 degrees or greater.

12. The color pattern formed substrate according to claim 10, wherein:
the ink-repellent property of the surface layer portion of the bank is better than that of the lower layer portion thereof and the contact angle between the surface layer portion and the color ink is 40 degrees or greater.

13. The color pattern formed substrate according to claim 10, wherein:
the bank comprises an ink repellent including a fluorine-containing compound.

14. The color pattern formed substrate according to claim 10, wherein:
the bank comprises an ink repellent including of a fluorine-containing compound and the fluorine-containing compound is an oligomer type one.

15. The color pattern formed substrate according to claim 10, wherein:
the color ink has been discharged with an ink-jet system.

16. The color pattern formed substrate according to claim 10, wherein:
the surface tension of the color ink is 35 mN/m or smaller.

17. The color pattern formed substrate according to claim 10, wherein:
the bank is composed of a single layer.

18. The color pattern formed substrate according to claim 10, wherein:
the color pattern formed substrate has a protective layer as the upper layer.

19. The color pattern formed substrate according to claim 10, wherein:
the bank is formed by using a bank formation ink comprising a black pigment, a photo-curable resin, a photo initiator, an ink repellent and fine particles, and the fine particles have a particle diameter of 500 nm or smaller.

20. The color pattern formed substrate according to claim 10, wherein:
the bank is formed by using a bank formation ink comprising a black pigment, a photo-curable resin, a photo initiator, an ink repellent and fine particles, and the content of the fine particles is from 10 weight % to 60 weight % relative to the total solids of the bank formation ink being 100 weight %.
